(19) United States
(12) Patent Application Publication
(10) Pub. No.: US 2019/0251792 A1
(43) Pub. Date: Aug. 15, 2019

(54) ENHANCING GAMING PAYOUTS THROUGH RANDOM, PERCEIVABLE ADVANCEMENT TOWARDS AN AWARD GRANT THRESHOLD

(71) Applicant: KING SHOW GAMES, INC., Minnetonka, MN (US)

(72) Inventor: Jacob LAMB, Maple Grove, MN (US)

(21) Appl. No.: 16/269,791

(22) Filed: Feb. 7, 2019

Related U.S. Application Data
(60) Provisional application No. 62/628,445, filed on Feb. 9, 2018.

(51) Int. Cl. G07F 17/32

(52) U.S. Cl. CPC G07F 17/3258; G07F 17/3211; G07F 17/3262; G07F 17/3293

(57) ABSTRACT

Systems, apparatuses and methods for enhancing payouts in gaming activities. A counter(s) is advanced for each gaming event played, and the current counter value is tracked. A presentation of the progress of the counter is presented to the player, and corresponds to the current counter value relative to the counter threshold where an award or award modifier will be presented in connection with game play. The award or award modifier is provided to the player when the perceivable presentation of progress of the counter has reached the award threshold, where the award modifier may currently or later be used to enhance a payout(s) of the gaming events.

### FIELD

This disclosure relates generally to games, and more particularly to systems, apparatuses and methods for enhancing payouts in gaming devices and activities.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to enhance gaming payouts in gaming activities.

In one embodiment, systems and methods are provided for enhancing awards in a gaming activity comprised of a sequence of playable gaming events. A counter is advanced for each gaming event played, and a current counter value is tracked. A perceivable presentation of the progress of the counter towards an award threshold is updated, where the updating of the perceivable presentation is commensurate with the current counter value. An award modifier is provided when the perceivable presentation of progress of the counter has reached the award threshold, where the award modifier is usable to enhance one or more payouts of the gaming events whether as a direct enhancement such as a multiplier or other augmentation of a payout(s) or as some other benefit to the player such as a wild card(s), card(s) replacement or other manner of increasing the player's potential gaming result.

In one embodiment, an apparatus is provided for enhancing payouts in an electronic poker game providing discrete poker hand events. The apparatus includes a display to present at least the electronic poker game and poker hand events, a user interface including at least one user input to enable a player to initiate the poker hand events, a wager input device structured to identify and validate player assets and to permit the player to play the poker hand events when the player assets are provided, a counter(s), and a processor (which may include one or more processing devices). The processor is configured to advance the counter for each poker hand event and track a current counter value, and to update a perceivable presentation of progress of the counter towards an award threshold, where the updating of the presentation is commensurate with the current counter value. The processor is configured to provide an award modifier in connection with the perceivable presentation of progress of the counter having reached the award threshold, where the award modifier may be applied to one or more payouts of the poker hand event to enhance a total payout.

In another embodiment of such an apparatus, the processor is configured to incrementally advance the counter by one each time a new one of the poker hand events is played, where in another embodiment the processor is configured to advance the counter nonconsecutively.

In one embodiment, the perceivable presentation of progress of the counter comprises a visual presentation of the current counter value relative to the award threshold, where the processor is configured to update the visual presentation of the current counter value as the counter is advanced for each poker hand event, and the display is configured to further present the visual presentation. In a more particular embodiment, the processor may be configured to update the visual presentation of the current counter value each time the current counter value reaches a new count plateau. In another particular embodiment, the processor is configured to update the visual presentation of the current counter value each time the current counter value is advanced.

In another embodiment of such an apparatus, the processor is configured to provide the award modifier as a multiplier, where the multiplier is multiplied by the one or more payouts of the poker hand event to increase the total payout.

In one particular embodiment, the award threshold involves a fixed count threshold of poker hand events, and the processor updates the perceivable presentation of progress of the counter towards the fixed count threshold. In an alternative embodiment, the award threshold involves a randomly-generated count threshold of poker hand events, and the processor updates the perceivable presentation of progress of the counter towards the randomly-generated count threshold.

In another embodiment, an apparatus is provided for enhancing payouts in an electronic poker game providing a plurality of concurrently-played poker hand events. The apparatus includes a display presenting the electronic poker game and the plurality of concurrently-played poker hand events, a user interface including at least one user input to enable a player to initiate play of the plurality of concurrently-played poker hand events, a wager input device structured to identify and validate player assets and to permit the player to play the plurality of concurrently-played poker hand events when the player assets are provided, at least one counter, and a processor. The processor is configured to advance the counter(s) in response to occurrence of each of the concurrently-played poker hand events, and to track at least one current counter value corresponding to a respective current value for each of the at least one counters. The processor is configured to update a perceivable presentation of progress of the counter(s) towards a respective award threshold, where the updating of the perceivable presentation is commensurate with the current counter value. The processor is further configured to provide an award modifier when the perceivable presentation of progress of a respective one of the counters has reached the respective award threshold, wherein the respective award modifier is applied to a payout(s) of the concurrently-played poker hand event to enhance a total payout.

In a particular embodiment of such an apparatus, the at least one counter involves a single counter, and the at least one current counter value relates to a single current counter value. In such an embodiment, the processor may be configured to advance the single counter in response to occurrence of any of the concurrently-played poker hand events, track the single current counter value corresponding to a current value for the single counter, update a perceivable presentation of progress of the single counter towards an award threshold, wherein the updating of the perceivable presentation is commensurate with the single current counter value, and provide an award modifier when the perceivable presentation of progress of the single counter has reached the award threshold, wherein the award modifier is applied to one or more payouts of the concurrently-played poker hand event to enhance a total payout.

In another particular embodiment of such an apparatus, the at least one counter includes multiple counters, each associated with a different one of the concurrently-played poker hand events. The at least one current counter value relates to a plurality of current counter values each associated with a different one of the plurality of counters. In such an embodiment, the processor is configured to advance each of the counters in response to occurrence of its associated one of the concurrently-played poker hand events, track each of the current counter values corresponding to a current value for each of the plurality of counters, update perceivable presentations of progress for each of the counters towards respective award thresholds, where the updating of each of the perceivable presentations is commensurate with its respective one current counter values, and provide an award modifier when a corresponding one of the perceivable presentations of progress of its respective one of the plurality of counters has reached its respective award threshold, where the award modifier is applied to one or more payouts of its associated one of the concurrently-played poker hand events to enhance a total payout.

In still other embodiments of such an apparatus, the processor is configured to advance each of the counters by a random amount within a known range in response to its respective one of the concurrently-played poker hand events being participated in. In an alternative embodiment, the processor is configured to advance each of the counters by a predetermined amount in response to its respective one of the concurrently-played poker hand events being participated in.

In yet another embodiment of such an apparatus, the counters are counters each associated with a different one of the plurality of concurrently-played poker hand events, where in other embodiments, a single counter is configured to count all of the concurrently-played poker hand events.

In another embodiment, an apparatus is provided for enhancing payouts in a gaming activity comprised of a sequence of playable gaming events. The apparatus includes a display presenting the gaming activity and playable gaming events, a user interface including at least one user input to enable a player to initiate the playable gaming events, a wager input device structured to identify and validate player assets and to permit the player to play the playable gaming events when the player assets are provided, at least one counter, and a processing arrangement. The processing arrangement is configured to advance the counter(s) for each gaming event played, track a current counter value corresponding to a current value of the counter(s) as it is advanced, update a perceivable presentation of progress of the at least one counter towards an award threshold, wherein the updating of the perceivable presentation is commensurate with the current counter value, and provide an award modifier when the perceivable presentation of progress of the counter has reached the award threshold, wherein the award modifier is usable to enhance one or more payouts of the gaming events.

In yet another representative embodiment, an apparatus is provided for enhancing payouts in an electronic poker game providing discrete poker hand events. The apparatus includes a display to present at least the electronic poker game and poker hand events, a user interface including at least one user input to enable a player to initiate the poker hand events, a wager input device structured to identify and validate player assets and to permit the player to play the poker hand events when the player assets are provided, a counter(s), and a processor (which may include one or more processing devices). The processor is configured to advance the counter for each predetermined event that occurs (e.g., hand played, hand value, minimum hand value, mystery/random event, etc.), track a current counter value, and to update a perceivable presentation of progress of the counter towards an award threshold, where the updating of the presentation reflects the current counter value. The processor is configured to provide one or more wild cards in connection with the perceivable presentation of progress of the counter having reached the award threshold, where the one or more wild cards may be used to increase a poker rank in one or more of the current and/or subsequent poker hand events.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIG. 3 depicts a representative methodology for providing a player-perceivable progression towards an award modifier.

FIG. 4 is a block diagram depicting a manner in which a counter or other manner of tracking progression may be used to award a payout modifier in a single-hand poker game.

FIG. 5 is a block diagram depicting a manner in which a plurality of counters may be used to award respective payout modifiers in a multi-hand poker game.

FIG. 6 depicts a series of stages of a single-hand poker game incorporating a perceivable progression towards an award modifier in accordance with the disclosure.

FIG. 7 depicts a representative manner in which a meter or other perceivable progression mechanism may be updated.

FIG. 8 depicts a representative example of a multi-hand poker game incorporating perceivable progression towards an award modifier in accordance with the disclosure.

FIGS. 9A-9E depict various representative manners for presenting the perceivable progress towards an award or award modifier.

FIG. 10 is a block diagram of a representative gaming apparatus for enhancing payouts by tracking gaming occurrences in poker activities.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing payouts (e.g., video poker winnings, slot game winnings, etc.) in a partially random yet perceivably advancing manner. The progress of the counter is displayed to the player to provide an indication, whether entirely accurate or in generalities, of when the player may be awarded an auxiliary award (bonus event, free games, etc.) and/or award modifier (e.g., multiplier). When the counter reaches the threshold, the player is awarded with the award/award modifier.

The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. poker, such as video poker) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses, gaming machines, etc.), gaming systems, and methods of operating these devices or systems to provide game play that involves a progression or evolution towards reaching an enhancement value(s), such as a payout modifier (e.g., multiplier) or other award enhancement. Some embodiments involve perceivably progressing towards the enhancement value(s), whereby the gaming participant is at least somewhat aware of how near the player is to being awarded an enhancement value(s). In other embodiments, the progression towards the enhancement value(s) may be partially or entirely concealed from the player. Alternative embodiments range from completely random advancement towards the enhancement value(s), to semi-random enhancement towards the enhancement value(s), and to set or known advancement towards the enhancement value(s) (e.g., a known count advancement towards a threshold count in response to each of a plurality of events, such as each spin in a slot game).

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, or other games of chance. Some of these other types of embodiments will be discussed below as variations to the examples illustrated. However, many other types of games can implement similar techniques and fall within the scope of this disclosed concept.

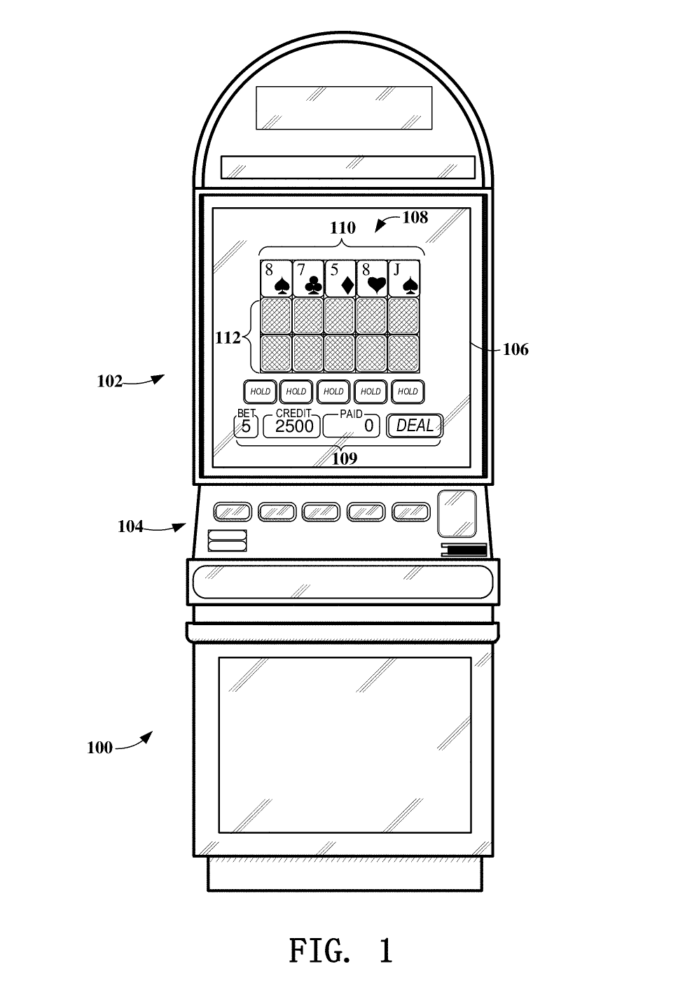

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

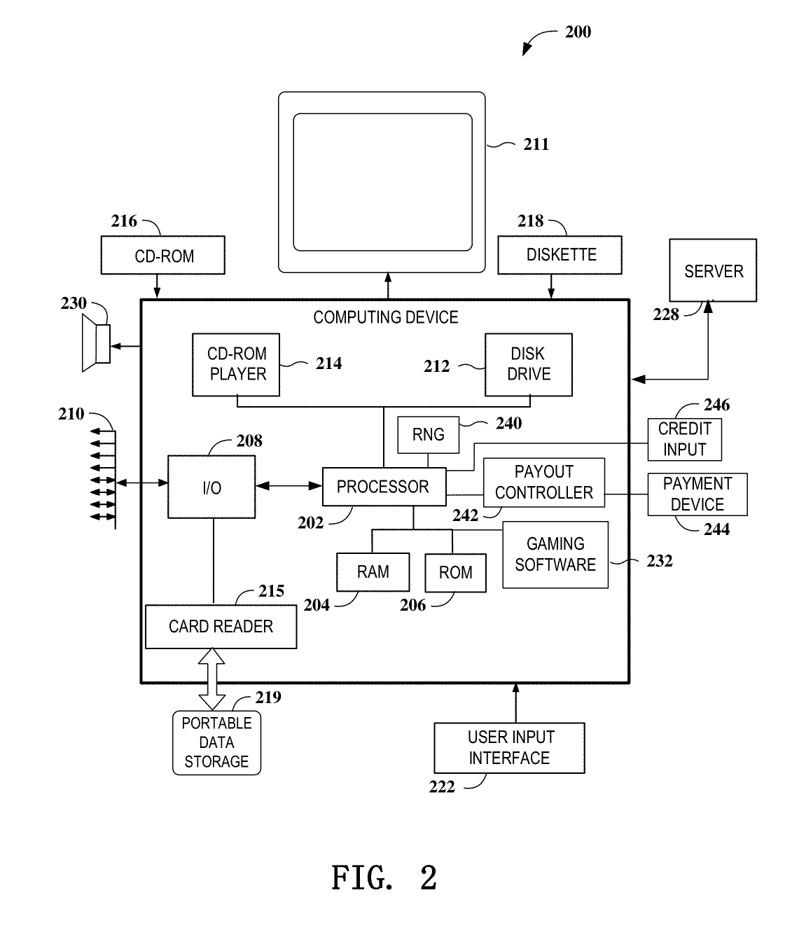

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some embodiments described herein, the primary gaming portion 108 may display a grid(s) or equivalent arrangement(s) of playing cards 110 forming one or more hands or other sets of cards in a card game, such as a poker game. In the illustrated example, a set of five playing cards 110 forms a video poker hand, which represents a portion of a game play event. For example, if the game play event is a video draw poker game, the gaming device 100 may deal five cards, allow the user to select cards to hold, deal replacements for the cards not held, and determine a payout based on the final cards in the hand. The illustration and description of five-card draw poker is for purposes of example and not of limitation, as the disclosure is applicable to numerous other card games, such as stud poker or hold'em poker, as well as other types of gaming activities and apparatuses, such as slot machines, dice, coins, etc. For example, some embodiments may relate to slot games, where the primary gaming portion 108 presents a grid (or equivalent arrangement) of symbols or other game elements in respective symbol locations (not shown), where the symbols or combinations of symbols determine gaming outcomes.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual cards to hold and/or selection of individual cards to discard and replace (e.g., in a draw poker embodiment), which subset of cards of a larger set of cards to hold/use for a final hand(s) (e.g., in some stud poker embodiments), wagering inputs, etc. The game display 106 of the display area 102 may include other features that are not shown, such as pay tables, navigation controls, etc.

Although FIG. 1 illustrates a particular implementation of some of the embodiments in a casino or electronic gaming machine (“EGM”), one or more devices may be programmed to play various embodiments of the disclosure. The concepts and embodiments described herein may be implemented, as shown in FIG. 1, as an electronic/video gaming machine or other special purpose gaming kiosk, or may be implemented via computing systems operating under the direction of local gaming software, and/or remotely-provided software such as provided by an application service provider (ASP). Such gaming machines may also utilize computing systems to control and manage the gaming activity, although these computing systems typically include specialized components and/or functionality to operate the particular elements of electronic gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor(s), such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display, or an electronic/video display such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in, for example, one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. In one embodiment, a counter(s) is advanced for each gaming event played, and the current counter value is tracked. A presentation of the progress of the counter is presented to the player, and corresponds to the current counter value relative to the counter threshold where an award or award modifier will be presented in connection with game play. The award or award modifier is provided to the player when the perceivable presentation of progress of the counter has reached the award threshold, where the award modifier may currently or later be used to enhance a payout(s) of the gaming events.

Many embodiments may be described in terms of an electronic poker game, where presented cards potentially form a result(s) that conforms to a predetermined winning outcome to determine payout awards. However, the principles described herein are equally applicable to other games of chance, as described herein and as will be readily apparent to those skilled in the art from the teachings herein.

In one representative embodiment of an electronic poker game, a meter or other depiction of a progression is associated with a poker hand(s). For example, the representation of progress towards receiving an award/award modifier may be a meter, graph, dial, numeric/alphanumeric output, or any other manner of depicting how close or far, whether with fine or coarse granularity, the player is to being awarded the prize, award, award modifier, etc. The meter may be associated with a respective one of a plurality of poker hands, such that each of a plurality of played poker hands may have a respective meter. In other embodiments, a meter may be used in connection with a plurality of played poker hands. Embodiments of a “meter” or other progression depiction involve providing a visual, audio, tactile, and/or other perceivable feedback of an advancement towards an award, award modifier, and/or other direct or indirect benefit to the player. For example, next to each poker hand in a multi-hand poker game may be a respective meter that illuminates section by section until the entire meter is illuminated—i.e. the progression is complete. In response to completion of the progression (i.e. the entire meter being illuminated in this example), the game generates a modifier, such as a multiplier, that may be used to enhance an award in a particular one or more of the poker hands, such as the current poker hand, the next poker hand played, the nth poker hand played, etc. Upon completion of the progression, the meter may be reset to begin a new progression towards obtaining an award modifier.

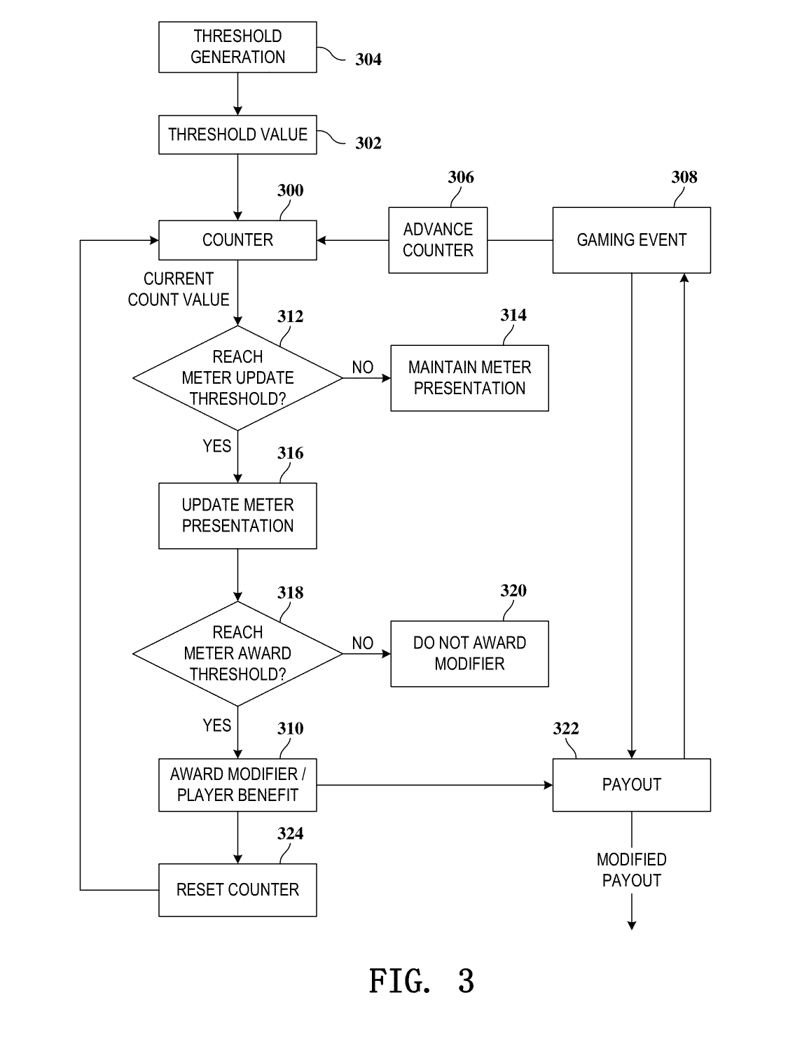

FIG. 3 is described in the context of such an electronic game embodiment, such as an electronic poker game, slot game, and/or other game of chance. This embodiment depicts a representative methodology for providing a player-perceivable progression towards an award modifier. The perceivable progression may alternatively or additionally be directed to an award or other player asset rather than an award modifier that adjusts or otherwise applies to another award(s).

In the representative embodiment of FIG. 3, the progression towards being awarded an award, or award modifier in this example, is implemented using a counter 300. The counter may be configured to count up (e.g., 1, 2, 3 . . . ), count down (e.g., 50, 49, 48 . . . ), count by unitary increments (e.g., 1, 2, 3 . . . ) or fractional increments (e.g., 1, 1.5, 2 . . . ), count by successive numbers/characters (e.g., 1, 2, 3 . . . ), count by consistent non-successive steps (e.g., 1, 4, 7, 10, 13 . . . ), count in a pattern (e.g., 1, 2, 4, 5, 7, 8, 10, 11 . . . ), count by random non-successive steps (e.g., 1, 12, 15, 16, 28 . . . ), or however desired. Thus, the “counter” 300 is named as such for purposes of illustration, but is not limited to a mechanism that performs only standard “counting” in its literal sense. For purposes of illustration, the representative example of FIG. 3 will assume a “count up” from an initial value (0 in this example) to a threshold value upon which an award modifier will be awarded to the player.

A threshold value 302 represents at least the threshold count value at which an award modifier will be awarded. The threshold value 302 may be, for example, an input that is stored, or may optionally be generated by a threshold generation module 304 that may randomly or systematically generate the same, or different, threshold values 302. For example, the threshold generation module 304 may generate a different threshold value 302 at various times or in response to an event(s) (e.g., when the counter 300 is reset) to provide some degree of randomness as to when the threshold is met and the award modifier is awarded to the player. As described more fully below, other and/or additional manners of providing such randomness may be accomplished in other manners, such as advancing 306 the counter by non-sequential amounts when another gaming event 308 is played.

The gaming event 308 represents one or more “plays” of a gaming activity, where the gaming activity may be a poker game, such as an electronic/video poker game, slot game, or other game where awards are provided (e.g., games of chance). For example, where the gaming activity is a video poker game, a gaming event 308 may represent a deal of one or more poker hands, i.e. a poker hand event, that are played until a result of that one or more poker hands occurs. In accordance with one embodiment, the counter 300 is advanced 306 in response to each gaming event 308 played. For example, in a video poker embodiment, the counter 300 is advanced 306 for each new dealt hand(s) of poker.

In some embodiments, what is counted and monitored towards a count threshold, may be other than the number of gaming events. In other words, while some embodiments count poker hands dealt or played, or slot game spins, or the like, other embodiments utilize other factors in which to count towards the count threshold. For example, a number of initial hands (e.g., draw poker hands before discarding), or a number of final hands (e.g., draw poker hands after replacement, or stud poker hands) that exhibit a particular poker rank, or minimum poker rank, or maximum poker rank, or other hand(s) feature may be counted towards the count threshold. For example, resulting hands having at least a particular poker rank (e.g., straight or better) may be counted towards the count threshold. As another example, the hands resulting in a “win” (e.g., providing a payout) may be counted towards the count threshold. As another example, the number of particular cards, card ranks, and/or card suits may be counted, such as counting towards a count threshold each time an Ace of Spades is dealt, or each time an Ace of Spades is used in a final hand, etc. Thus, these and other hand and/or card features may serve as the counted items towards the count threshold.

In another embodiment, mystery/random events may occur during play, and such mystery/random events may be counted towards the count threshold. For example, a symbol, sub-symbol, grid overlay or other presented indicia, whether presented in connection with the cards/symbols or not, may be randomly presented and counted towards the count threshold. Thus, these and other random events may serve as the counted items towards the count threshold.

Thus, as this indicates, the counter may be advanced for any desired reason. Embodiments herein may be described in terms of advancing the counter(s) in response to participation in gaming events (e.g., dealt poker hands or dealt multi-hand poker events, slot game spins, etc.), although the principles are equally applicable to any desired game features that may be counted towards a count threshold.

In still other embodiments, multiple counters may be maintained, whereby award modifiers, wild functionality, and/or other player benefits may be presented upon particular counters reaching their respective count thresholds. Thus, descriptions herein that are described in terms of a single counter are equally applicable to the use of multiple counters.

In one embodiment, to provide random or stochastic results, the counter 300 may be advanced 306 in a random or partially random manner, so that reaching the counter 300 threshold value 302 is not entirely predictable. For example, for each poker deal, the advance counter 306 action may involve generating a number (X) between, for example, one and fifty. That randomly-generated number is then added to the respective poker hand's current counter value of the counter 300 in order to increment or otherwise advance the counter 300 towards the threshold value 302. In this manner, the number of gaming events 308 played to reach the threshold value 302 and provide an award modifier (or other award) will vary. In other embodiments, the counter may be advanced in a non-random fashion, such as by a set count (e.g., one), whereby the number of gaming events 308 played to reach the threshold value 302 will be consistent. Thus, in one representative embodiment, when a gaming event 308 is played by a player, the counter 300 is accordingly advanced 306 towards a threshold value 302 by a random number within a predetermined range of numbers, and when the counter 300 has reached the threshold value 302, an award modifier 310 is provided to the player to enhance the value of an award(s) obtained from playing the gaming event 308.

In one embodiment, a meter (which includes any perceivable depiction of how far the counter has advanced towards providing an award modifier) is provided for each gaming event 308 played. For example, in a single-hand poker embodiment, a meter is provided for that poker hand. In a multi-hand poker embodiment, a single meter may be used for all of the poker hands and used for a particular one of the hands (e.g., the first winning hand, the highest paying winning hand, etc.) or for a plurality or all of the hands. In other embodiments, each poker hand in a multi-hand poker game may be provided with a separately-operable counter 300 and respective meter.

The meter may provide progress feedback with relatively fine granularity, whereby a precise representation of the current counter 300 value is depicted on the meter (e.g., if the current counter 300 value is 68 of 100, a depiction may show the counter being 68% to reaching an award modifier grant). In other embodiments, the meter may provide progress feedback with more coarse granularity, whereby segments of the meter show progression only at stages (e.g., a five-stage meter might show the first two of five segments highlighted when the current count is in the range of 40-59 of 100). The illustrated embodiment accounts for such a coarse granularity, whereby the meter presentation changes only when the current counter 300 value reaches a new range of current counter values. Thus, in one embodiment, when the counter 300 has advanced 306 in response to another gaming event 308 (or other predetermined action, such as in response to another gaming event 308 meeting some predetermined criteria), it is determined 312 whether the meter update threshold has been reached. If not (even though the current counter value may still be advancing towards the award threshold value), the meter presentation is maintained 314 at its current level. If it is determined 312 that the meter update threshold has been reached, the meter presentation is updated 316, thereby providing a perceivable progression towards obtaining the award modifier 310.

As the current count value continues to advance towards the threshold value 302, it is determined 318 whether the current count value has reached the meter award threshold. If not, no award modifier is provided as depicted at block 320, and play may optionally return to a new gaming event 308, or may simply end, or take any other action. If the current count value has reached the award threshold, the award modifier is provided 310, and is available to be applied to any payout 322, resulting in a modified payout. For example, the award modifier 310 may be a multiplier that is applied to a payout 322, resulting in a modified payout. The modifier 310 that is awarded may be a fixed modifier, randomly selected modifier, cycling modifier (e.g., 2×, 3×, 4×, 5×, 2×, 3×, 4×, etc.), etc. Further, the modifier may be a multiplier or any other mathematical function to enhance or otherwise adjust one or more payouts 322. In other embodiments, the award modifier 310 may instead be an actual award, such as a fixed award amount, a prize, free games, wild functionality for one or more cards, card(s) modification to a potentially more favorable card(s), etc. Thus, while block 310 is depicted as an award modifier, it should be recognized that other analogous benefits may instead (or additionally) be provided, such as noted above and other (e.g., modification of a card(s) to exhibit wild functionality, a high value card(s), a card(s) determined to be beneficial in the particular hand(s), etc.). When the award modifier 310 or other player benefit has been provided, the counter 300 may be reset 324 to initiate a new count towards the player receiving an award modifier 310 or other award.

It should be noted that FIG. 3 and other flow diagrams herein represent methods in which gaming devices and/or systems can be operated in accordance with the disclosure. While certain processes or portions of processes may be shown in a particular order in these flow diagrams, the order of these processes may be changed in other embodiments without deviating from the scope or spirit of this concept. Accordingly, unless otherwise noted, the order of the processes shown is for illustrative purposes only and is not meant to be restrictive. Additional game processes may also be included between various processes even though they are not shown in these flow diagrams for clarity purposes. Each of the processes may be performed by components in a single game device, such as by a game processor(s), or may be performed in part or whole by a remote server(s) or processor(s) connected to the gaming device via a network. Each process may be encoded in instructions that are stored in one or more memories, a computer-readable medium(s), or another type of storage device(s). The exemplary methods depict representative embodiments of how game operations may be implemented. As discussed herein, many variations exist which may require additional, fewer, or different processes to complete.

FIG. 4 is a block diagram depicting a manner in which a counter 400 or other manner of tracking progression may be used to award a payout modifier 402 or other player benefit (e.g., wild card functionality, card value modification, additional hand(s) to play, etc.) in a single-hand poker game 404. A poker hand 406 is dealt, which advances the counter 400. When the counter 400 reaches a threshold (T) 408, the payout modifier 402 and/or other player benefit is awarded, and applied to any payout resulting from the poker hand 406 to arrive at a modified payout 410.

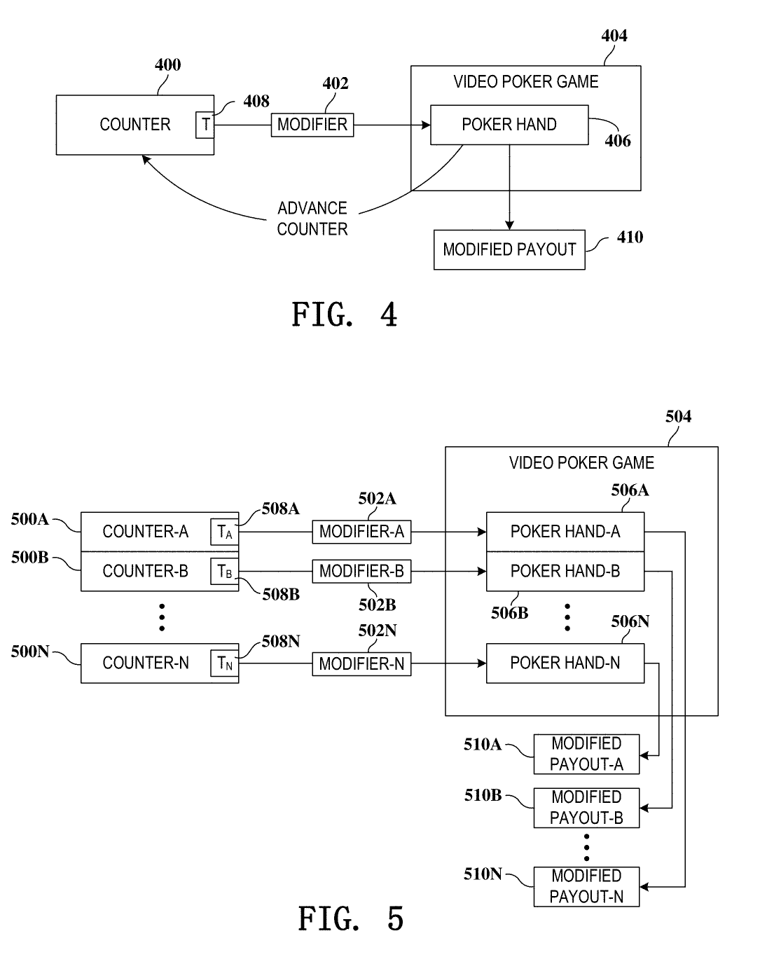

FIG. 5 is a block diagram depicting a manner in which a plurality of counters 500A, 500B, 500N may be used to award respective payout modifiers 502A, 502B, 502N in a multi-hand poker game 504. While the embodiment of FIG. 5 involves “modifiers” such as multipliers and/or other payout modifiers, the modifiers 502A, 502B, 502N may alternatively represent wild functionality applicable to one or more cards of one or more hands, improved/updated cards for one or more cards in one or more hands, or other player benefit that increases the chances of the player obtaining an award, and/or increasing the ultimate payout to the player, and/or increasing the frequency of payouts to the player, etc.

In the embodiment of FIG. 5, a plurality of poker hands are dealt, such as poker hand-A 506A, poker hand-B 506B, and possibly even more through some number of poker hands represented by poker hand-N 506N. Embodiments such as that associated with FIG. 5 enable a player to play multiple poker hands at the same time, including but not limited to multi-hand draw poker where held cards are replicated in one or more additional concurrently played poker hands.

When counter-A 500A reaches a counter threshold (TA) 508A, the respective payout modifier 502A is awarded, and applied to any payout resulting from the poker hand 506A to arrive at a modified payout-A 510A. Analogously, when counter-B 500B reaches a counter threshold (TA) 508B, the respective payout modifier 502B is awarded, and applied to any payout resulting from the poker hand 506B to arrive at a modified payout-B 510B. This may occur for any subset or all of the poker hands 506A, 506B, 506N being played, through poker hand-N 506N, whereby counter-N 500N reaches a counter threshold (TA) 508N, the respective payout modifier 502N is awarded, and applied to any payout resulting from the poker hand 506N to arrive at a modified payout-N 510N

In other embodiments, a single counter may be used for a plurality of poker hands, whereby any one or more of the poker hands resulting in a payout may be modified by the modifier resulting from the single counter reaching the counter threshold.

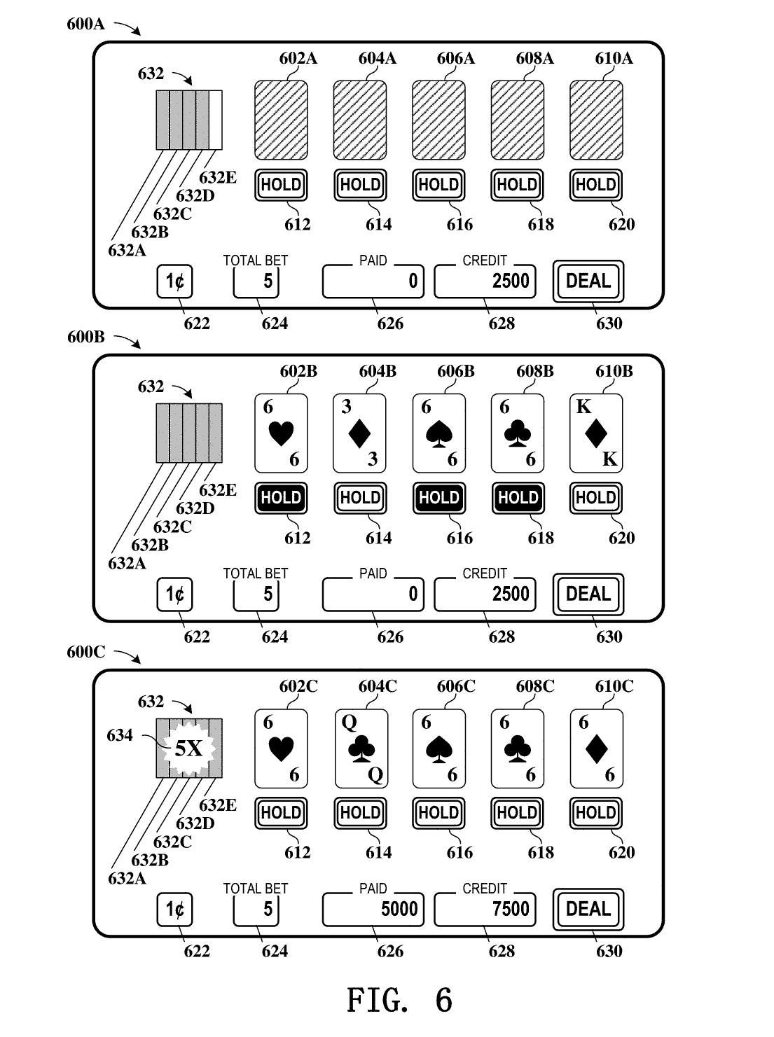

FIG. 6 depicts a series of stages of a single-hand poker game incorporating a perceivable progression towards an award modifier in accordance with the principles described herein. In this representative embodiment, the single-hand poker game is an electronic or video poker game, where three display screens 600A, 600B, 600C depict the progression of the poker game. The single-hand poker game in this embodiment is assumed to be a five-card draw poker embodiment, beginning with five cards 602A, 604A, 606A, 608A, 610A, and each having respective “HOLD” actuators 612, 614, 616, 618, 620 associated therewith to enable a desired card to be held and not replaced. It should be noted that the description of FIG. 6 is equally applicable to other poker games, such as stud poker, etc. The user interface to assist in playing the poker game may include various informational and/or interface items, such as the monetary denomination 622 to play the game, total bet 624, amount paid 626, credit total 628, a “DEAL” actuator 630 to cause the cards to be dealt and/or replaced, etc.

Additionally, a mechanism for facilitating a perceivable progression towards a payout modifier is provided, which in the illustrated embodiment is a five-stage meter 632 with stages 632A, 632B, 632C, 632D and 632E. As the stages of the meter 632 randomly progress to a point where the meter 632 is filled or at some other threshold, the various stages 632A, 632B, 632C, 632D, 632E are marked in a manner to make the progress known.

As depicted via display screen 600B, cards 602B, 604B, 606B, 608B and 610B are revealed to the player, who has opted to hold cards 602B, 606B and 608B using HOLD buttons 612, 616 and 618 respectively. This results in discarding cards 604B and 608B, which are replaced as depicted at display screen 600C. More particularly, cards 604C and 610C become replacement cards for those cards that were not held, and the player has won four-of-a-kind (four sixes, namely cards 602C, 606C, 608C, 610C). For purposes of this example, it is assumed that this provides a payout of 1000 credits.

In this example, when the player has initiated play by paying credits or other player assets to obtain the poker hand, a hidden counter (such as embedded in programming code and operable via a processor or other hardware) or other progression tracking mechanism is advanced or otherwise modified. In this example, when the counter advanced, the final stage 632E fills, meaning that the counter has reached the counter threshold value where an award modifier will be granted to the player. At display screen 600C, a multiplier of five, i.e. 5X multiplier 634, is awarded in this embodiment. Since the payout for the poker hand result was 1000 credits, when multiplied by the awarded payout modifier of 5X, the total paid 626 is 5000 credits.

The modifier 634 may be fixed, such that it always provides the same modifier when the progression has advanced to the point where the modifier will be granted. In other embodiments, the modifier 634 may be randomly selected, such as within some range of modifiers. As an example, the modifier 634 may randomly choose between a 2× and 20× (i.e. two times and twenty times) multiplier, with some average such as a 6× average modifier.

In still other embodiments, the modifier 634 may represent a modifier to a card(s) and/or hand(s) being played. For example, the awarded “modifier” 634 may be a wild card, that may be used on the current hand, and/or a future hand(s), etc. As a more particular example, the player may be awarded with a “modifier” 634 that represents a wild card, which can serve as any card in the deck, and may be awarded on a subsequent hand in a multi-hand poker game (e.g., where multiple poker hands are played concurrently), and/or may be awarded on a subsequent hand when a new poker event (e.g., a new poker deal) occurs, etc. Thus, the modifier 634 may represent any awarded benefit usable by the player to potentially increase the chances of obtaining an award and/or the actual value obtained by winning an award.

In the illustrated embodiment, the awarded modifier 634 is provided for the present poker hand, and can therefore be used for the present poker hand. In other embodiments, the awarded multiplier is used, or usable, on a subsequent poker hand such as the next poker hand played.

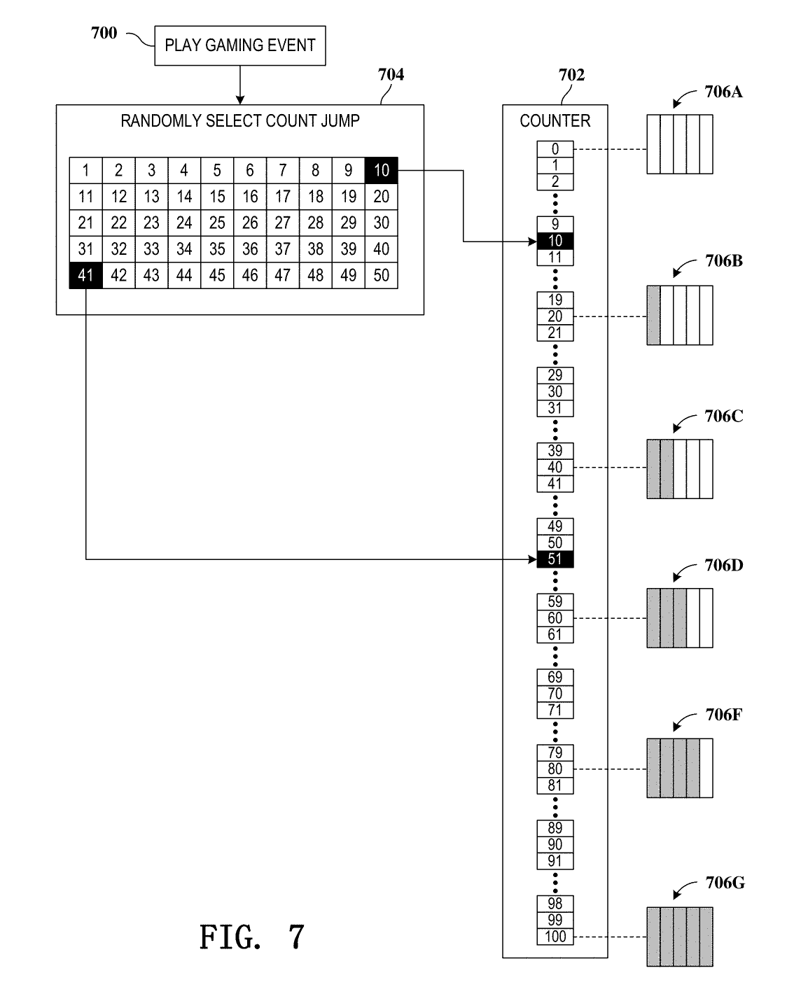

FIG. 7 depicts a representative manner in which a meter or other perceivable progression mechanism may be updated. As previously noted, the meter may reflect the precise current count of the counter, or alternatively may have a coarser granularity where visual or other perceivable updates occur when certain plateaus are reached. Furthermore, while some embodiments involve counting by a set value (e.g., 1), other embodiments involve counting in a less predictable manner, such as by randomly selecting the jump in which the count will make.

In the example of FIG. 7, a gaming event such as a video poker game is played 700. Each time the video poker game is played, i.e. each time a new poker deal is paid for and played, the counter 702 may be advanced. However, in this embodiment, the counter 702 is not advanced by a fixed amount, but rather is advanced by a randomly selected count jump 704. On each deal, for each hand generated, a number within a certain range may be randomly selected, such as a random number between 1 and 50 (and in some embodiments with a weighted arithmetic mean/average, such as 20). The randomly selected count jump 704 depicts such an example, where before a gaming event 700 is played, the counter is (for example) at zero. The meter 706A therefore has no stages filled, and is “empty.”

In this example, the next gaming event played 700 results in a randomly selected count jump 704 of 10, which sets the counter 702 to a current count value of 10. Because the meter has not reached its first plateau level yet (a count of 20 in this example), the meter 706A remains empty.

The next gaming event played 700 results in a randomly selected count jump 704 of 41, which sets the counter 702 to a current count value of 51. In this case, the plateau of a current count value of 40 has been met/exceeded, thereby causing two of the meter stages to reflect this advancement, as depicted at meter 706C. This process continues as the player participates in more gaming events 700, until the counter 702 reaches its threshold value (100 in this example), where the meter 706G may reflect this advancement by having all five stages of the meter 706G illuminated, colored, or otherwise distinguished from “empty” stages. Thus, in this embodiment, visual updates to the progress meter occurs as count value plateaus are reached, and count values are randomly advanced.

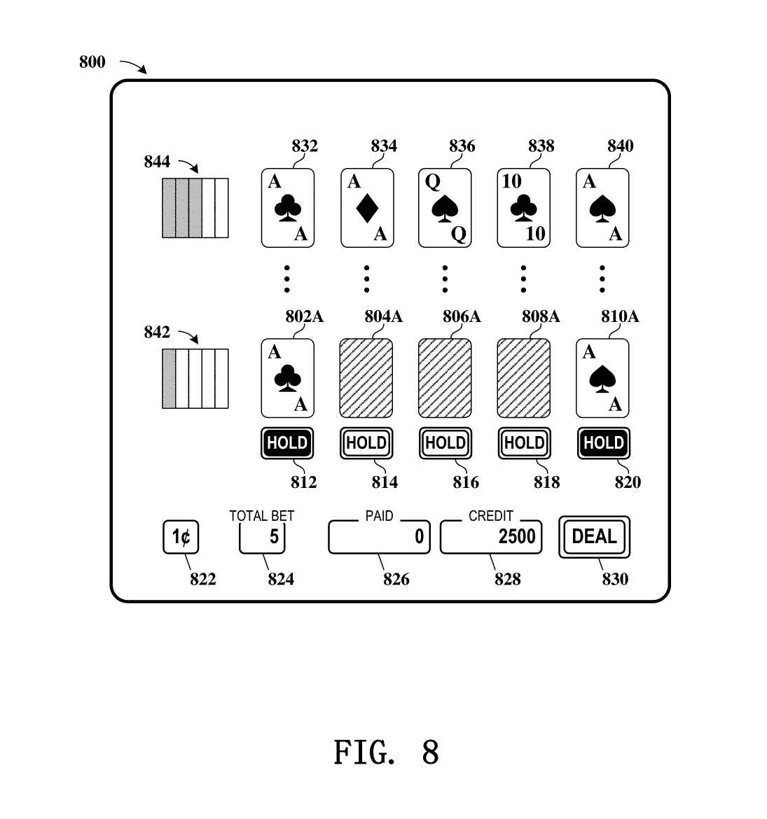

FIG. 8 depicts a representative example of a multi-hand poker game incorporating perceivable progression towards an award modifier in accordance with the principles described herein. In this example, the multi-hand poker game is an electronic or video poker game viewable via a display screen 800. The multi-hand poker game in this embodiment is assumed to be a five-card draw poker embodiment, beginning with five cards 802, 804, 806, 808, 810, and each having respective “HOLD” actuators 812, 814, 816, 818, 820 associated therewith to enable a desired card to be held and not replaced. It should be noted that the description of FIG. 6 is equally applicable to other poker games, such as stud poker, etc. The user interface to assist in playing the poker game may include various informational and/or interface items, such as the monetary denomination 822 to play the game, total bet 824, amount paid to the player 826, credit total 828, a “DEAL” actuator 830 to cause the cards to be dealt and/or replaced, etc.

The representative draw poker game is played as was described in connection with FIG. 6, except that one or more additional hands may be concurrently played, such as the additional hand having cards 832, 834, 836, 838, 840. In one embodiment, when the player holds a card(s), such as cards 802A, 810A, those cards are replicated into the respective card positions of one or more of the other hands, such as card positions 832 and 840. In such embodiments, or embodiments where multiple poker hands are played concurrently without replication of held cards across hands, a separate perceivable progress meter may be provided for each hand. In this example, there are two hands shown, and respective progress meters 842, 844 for each hand. Therefore, award modifiers may be awarded at different times for different hands.

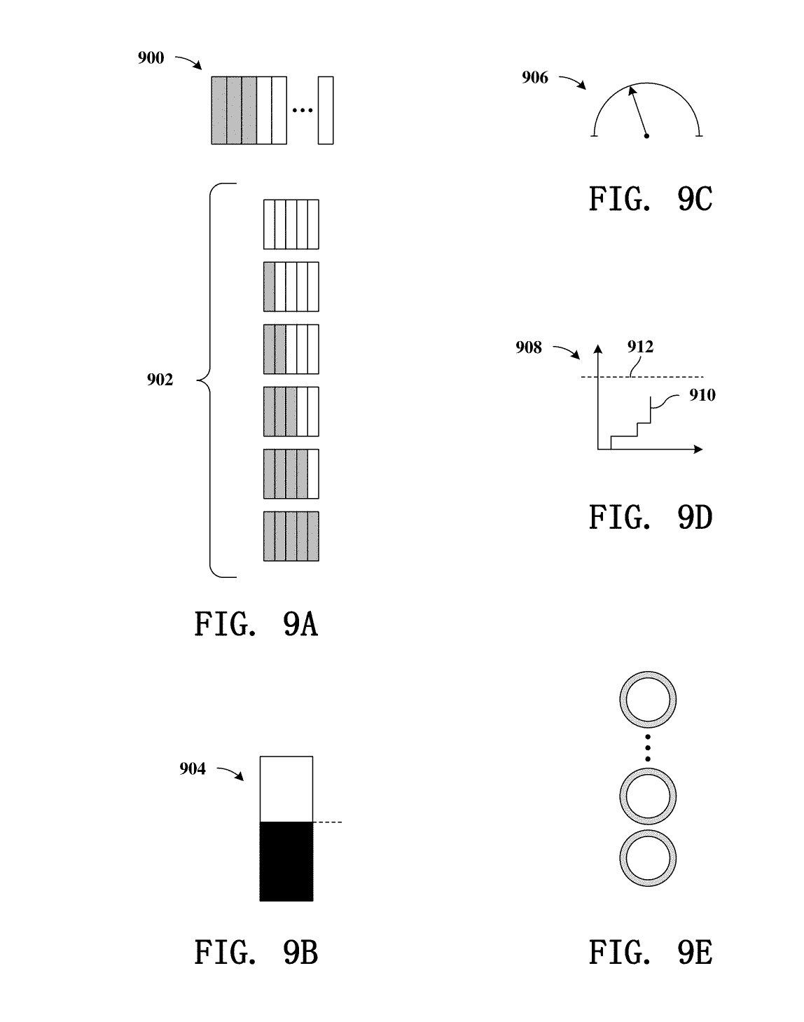

As previously noted, any manner of enabling a player to perceive the progress (whether precise or coarse granularity) may be employed. FIGS. 9A-9E depict various representative manners for presenting the perceivable progress towards an award or award modifier. A multi-stage meter 900 is shown at FIG. 9A, which may be any desired length/size. The various possible progress indications 902 for a five-stage meter is shown, ranging from all stages clear to all stages filled. Meter 904 of FIG. 9B shows a continuous and progressive quantity, and FIG. 9C depicts a dial 906 that points to a number or value to identify the progress. Charts or graphs 908 of FIG. 9D may be used, where a current value 910 is depicted climbing towards the count threshold value 912. FIG. 9E shows yet another example, where instead of lighting or otherwise distinguishing sections of a meter, the player may receive animated or otherwise electronically-depicted coins (or other objects) as an overlay on some portion of the screen, and when collecting a fixed or random number of coins, the award/award modifier is granted to the player.

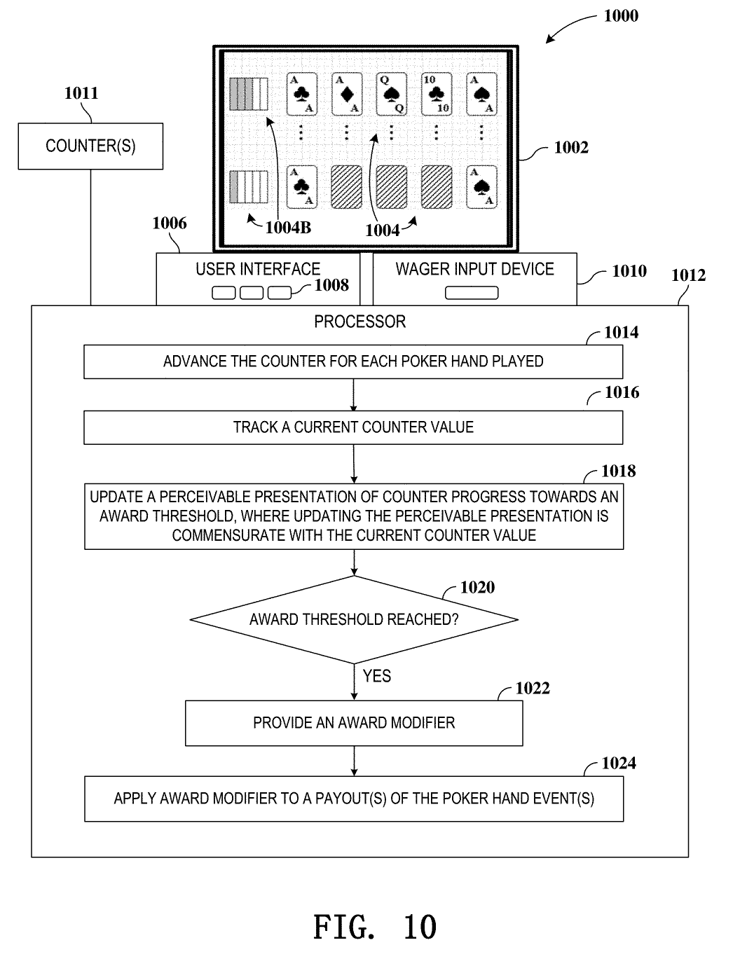

FIG. 10 is a block diagram of a representative gaming apparatus for enhancing payouts by tracking gaming occurrences in poker activities. In the embodiment of FIG. 10, a poker device (e.g., video poker machine) 1000 is provided on which players can play slot games. Other games may instead be used as a primary game, such as slot games or other games involving symbols or indicia in the determination of winning results. The representative poker device 1000 includes at least a display(s) 1002 presenting a single or multiple poker hands 1004A and potentially count values 1004B. A user interface 1006 is provided that includes at least one user input 1008 to enable a player to initiate and participate in poker hands 1004A presented via the display 1002, and a wager input device 1010 structured to identify and validate player assets and ultimately permit the player to play the poker game events when the player assets are provided. One or more counters 1011 are provided, where the “counter(s)” 1011 represents any hardware and/or programmable device(s) to maintain a value(s) of the progress towards an award threshold.

A processor 1012 is configured to, in one embodiment, advance 1014 the counter 1011, for each poker hand played, and track 1016 a current counter value obtainable via the counter(s) 1011. A perceivable presentation, such as a visual display, of the counter 1011 progress towards an award threshold is updated 1018, where such updating 1018 is commensurate with the current counter value, whether on a one-to-one basis, grouped (e.g., updating 1018 on every nth count value), etc. When the award threshold is reached 1020, an award modifier(s) is awarded 1022, and applied 1024 to a payout(s) occurring on one or more of the poker hands being played.

Other embodiments related to that of FIG. 10 include multi-hand card (e.g., poker) embodiments, where a single counter may count hands played whether in a single-hand embodiment (i.e. one hand played at a time) or in a multi-hand embodiment (i.e. more than one hand played concurrently). Another embodiment related to that of FIG. 10 is where the gaming activity is a slot game or other wagering game rather than a poker event.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention covers alternatives, modifications, and equivalents that come within the scope and spirit of the principles set out herein and/or in the appended claims.

What is claimed is:

1. An apparatus for enhancing payouts in an electronic poker game providing discrete poker hand events, comprising:
a display presenting the electronic poker game and poker hand events;
a user interface including at least one user input to enable a player to initiate the poker hand events;
a wager input device structured to identify and validate player assets, and to permit the player to play the poker hand events when the player assets are provided;
a counter; and
a processor configured to:
advance the counter for each poker hand event and track a current counter value;
update a perceivable presentation of progress of the counter towards an award threshold, wherein the updating of the perceivable presentation is commensurate with the current counter value; and
provide an award modifier when the perceivable presentation of progress of the counter has reached the award threshold, wherein the award modifier is applied to one or more payouts of the poker hand event to enhance a total payout.

2. The apparatus of claim 1, wherein the processor is configured to incrementally advance the counter by one each time a new one of the poker hand events is played.

3. The apparatus of claim 1, wherein the processor is configured to incrementally advance the counter by one each time a new one of the poker hand events is played.

4. The apparatus of claim 1, wherein the perceivable presentation of progress of the counter comprises a visual presentation of the current counter value relative to the award threshold, and wherein:
the processor is configured to update the visual presentation of the current counter value as the counter is advanced for each poker hand event; and
the display is configured to further present the visual presentation.

5. The apparatus of claim 4, wherein the processor is configured to update the visual presentation of the current counter value each time the current counter value reaches a new count plateau.

6. The apparatus of claim 4, wherein the processor is configured to update the visual presentation of the current counter value each time the current counter value is advanced.

7. The apparatus of claim 1, wherein the processor is configured to provide the award modifier as a multiplier, wherein the multiplier is multiplied by the one or more payouts of the poker hand event to increase the total payout.

8. The apparatus of claim 1, wherein the award threshold comprises a fixed count threshold of poker hand events, and wherein the processor is configured to update the perceivable presentation of progress of the counter towards the fixed count threshold.

9. The apparatus of claim 1, wherein the award threshold comprises a randomly-generated count threshold of poker hand events, and wherein the processor is configured to update the perceivable presentation of progress of the counter towards the randomly-generated count threshold.

10. An apparatus for enhancing payouts in an electronic poker game providing a plurality of concurrently-played poker hand events, comprising:
a display presenting the electronic poker game and the plurality of concurrently-played poker hand events;
a user interface including at least one user input to enable a player to initiate play of the plurality of concurrently-played poker hand events;
a wager input device structured to identify and validate player assets, and to permit the player to play the plurality of concurrently-played poker hand events when the player assets are provided;
at least one counter; and
a processor configured to:
advance the at least one counter in response to occurrence of each of the concurrently-played poker hand events;
track at least one current counter value corresponding to a respective current value for each of the at least one counters;
update a perceivable presentation of progress of the at least one counter towards a respective award threshold, wherein the updating of the perceivable presentation is commensurate with the current counter value; and
provide an award modifier when the perceivable presentation of progress of a respective one of the at least one counters has reached the respective award threshold, wherein the respective award modifier is applied to one or more payouts of the concurrently-played poker hand event to enhance a total payout.

11. The apparatus of claim 10, wherein the at least one counter comprises a single counter, and the at least one current counter value comprises a single current counter value, and wherein the processor is configured to:
advance the single counter in response to occurrence of any of the concurrently-played poker hand events;
track the single current counter value corresponding to a current value for the single counter;
update a perceivable presentation of progress of the single counter towards an award threshold, wherein the updating of the perceivable presentation is commensurate with the single current counter value; and
provide an award modifier when the perceivable presentation of progress of the single counter has reached the award threshold, wherein the award modifier is applied to one or more payouts of the concurrently-played poker hand event to enhance a total payout.

12. The apparatus of claim 10, wherein the at least one counter comprises a plurality of counters each associated with a different one of the plurality of concurrently-played poker hand events, and wherein the at least one current counter value comprises a plurality of current counter values each associated with a different one of the plurality of counters, and wherein the processor is configured to:
advance each of the plurality of counters in response to occurrence of its associated one of the concurrently-played poker hand events;
track each of the plurality of current counter values corresponding to a current value for each of the plurality of counters;
update perceivable presentations of progress for each of the counters towards respective award thresholds, wherein the updating of each of the perceivable presentations is commensurate with its respective one current counter values; and
provide an award modifier when a corresponding one of the perceivable presentations of progress of its respective one of the plurality of counters has reached its respective award threshold, wherein the award modifier is applied to one or more payouts of its associated one of the concurrently-played poker hand events to enhance a

13. The apparatus of claim 12, wherein the processor is configured to advance each of the plurality of counters by a random amount within a known range in response to its respective one of the concurrently-played poker hand events being participated in.

14. The apparatus of claim 12, wherein the processor is configured to advance each of the plurality of counters by a predetermined amount in response to its respective one of the concurrently-played poker hand events being participated in.

15. The apparatus of claim 10, wherein the at least one counter comprises a plurality of counters each associated with a different one of the plurality of concurrently-played poker hand events.

16. The apparatus of claim 10, wherein the at least one counter comprises a single counter configured to count all of the concurrently-played poker hand events.

17. An apparatus for enhancing payouts in a gaming activity comprised of a sequence of playable gaming events, comprising:
a display presenting the gaming activity and playable gaming events;
a user interface including at least one user input to enable a player to initiate the playable gaming events;
a wager input device structured to identify and validate player assets, and to permit the player to play the playable gaming events when the player assets are provided;
at least one counter; and
a processor configured to:
advance the at least one counter for each gaming event played;
track a current counter value corresponding to a current value of the at least one counter as it is advanced;
update a perceivable presentation of progress of the at least one counter towards an award threshold, wherein the updating of the perceivable presentation is commensurate with the current counter value; and
provide an award modifier when the perceivable presentation of progress of the counter has reached the award threshold, wherein the award modifier is usable to enhance one or more payouts of the gaming events.

18. The apparatus of claim 17, wherein the processor is configured to advance the at least one counter by advancing the at least one counter in a nonconsecutive random manner.

19. The apparatus of claim 17, wherein the processor is configured to update the perceivable presentation of progress by updating the perceivable presentation when the current counter value reaches count plateaus.

20. The apparatus of claim 17, wherein the processor is configured to provide the award modifier by providing a multiplier value when the perceivable presentation of progress of the counter has reached the award threshold, and wherein the processor is further configured to enhance the one or more payouts by multiplying the multiplier value times the one or more payouts.
